(19) United States
(12) Patent Application Publication
(10) Pub. No.: US 2024/0396350 A1
(43) Pub. Date: Nov. 28, 2024

(54) POWER SUPPLY CIRCUIT

(71) Applicant: ASUSTeK COMPUTER INC., Taipei City (TW)

(72) Inventors: Bo-Siang Cheng, Taipei City (TW); Hsiang-Jui Hung, Taipei City (TW); Sheng-Chieh Su, Taipei City (TW); Min-Hou Kuo, Taipei City (TW); Jia-Ching Huang, Taipei City (TW); Yen-Yong Wu, Taipei City (TW)

(73) Assignee: ASUSTeK COMPUTER INC., Taipei City (TW)

(21) Appl. No.: 18/424,873

(22) Filed: Jan. 29, 2024

(30) Foreign Application Priority Data
May 23, 2023 (TW) 112119035

(51) Int. Cl. H02J 7/00

(52) U.S. Cl. CPC H02J 7/00712; H02J 7/0048; H02J 7/0063; H02J 7/0068

(57) ABSTRACT

A power supply circuit is adapted to an electronic device. The power supply circuit includes a drive circuit, a feedback resistor circuit, a battery module and a controller. The drive circuit receives a charger boost indication signal and generates a drive signal accordingly. The feedback resistor circuit has a feedback resistance value changing in response to the drive signal and receives a DC power supply to supply power to a system component. The battery module provides a battery power supply to the system component. The controller controls the battery power supply provided by the battery module according to the feedback resistance value. When the system component is operating in a heavy load state, the controller transmits the corresponding charger boost indication signal to the drive circuit, so as to reduce the feedback resistance value through the drive signal.

### CROSS-REFERENCE TO RELATED APPLICATION

This application claims the priority benefit of Taiwan application serial no. 112119035,filed on May 23, 2023. The entirety of the above-mentioned patent application is hereby incorporated by reference herein and made a part of this specification.

### BACKGROUND

### Technical Field

The present disclosure relates to a power supply circuit capable of making full use of DC power supply supplied by a power adapter.

### Description of Related Art

Generally speaking, almost all existing notebook computers support a charger boost function. When the boost function of the charger is turned on, the power adapter and the battery module simultaneously supply electrical energy (power) to system components. However, when the system components are operating under heavy load, the power of the DC power supply supplied by the power adapter will be locked at a power limit value (for example, 85% of the maximum rated output power of the power adapter), resulting that the rest of required power must be carried by the battery module. As a result, when the system components are operating under heavy load, even if the power adapter is plugged in, the battery power supply will continue to decrease rapidly, resulting in poor user experience and perception of operation.

### SUMMARY

The present disclosure provides a power supply circuit adaptable for electronic devices. The power supply circuit includes a drive circuit, a feedback resistor circuit, a battery module and a controller. The drive circuit receives a charger boost indication signal and generates a drive signal accordingly. The feedback resistor circuit is coupled to the drive circuit, has a feedback resistance value that changes in response to the drive signal, and receives the DC power supply to supply power to the system component. The battery module provides battery power supply to system component. The controller is coupled to the drive circuit, the feedback resistor circuit and the battery module, and controls the battery power supply supplied by the battery module according to the feedback resistance value. When the system component is operating in a heavy load state, the controller sends a corresponding charger boost indication signal to the drive circuit, so as to reduce the feedback resistance value through the drive signal.

Based on the above, the power supply circuit of the present disclosure may actively reduce the feedback resistance value of the feedback resistor circuit when the system component is operating in a heavy load state, thereby influencing the controller's judgment on the current information of the DC power supply, so as to break the power limit of the power adapter. Even when the system component is operating in a heavy load status, it is possible to increase the power supply percentage of the DC power supply supplied by the power adapter, and reduce the electric energy (power) supplied by the battery power supply. In this way, it is possible to prevent the battery power supply from dropping rapidly even when the power adapter is plugged in, and avoid bad user experience and perception of operation.

In order to allow the above-mentioned features and advantages of the present disclosure to be more comprehensible, the specific examples below are described in detail in conjunction with the accompanying drawings.

### BRIEF DESCRIPTION OF THE DRAWINGS

FIG. 1 is a schematic block diagram of an electronic device provided with a power supply circuit according to an embodiment of the present disclosure.

FIG. 2 is a schematic block diagram of a power supply circuit according to an embodiment of the present disclosure.

### DESCRIPTION OF THE EMBODIMENTS

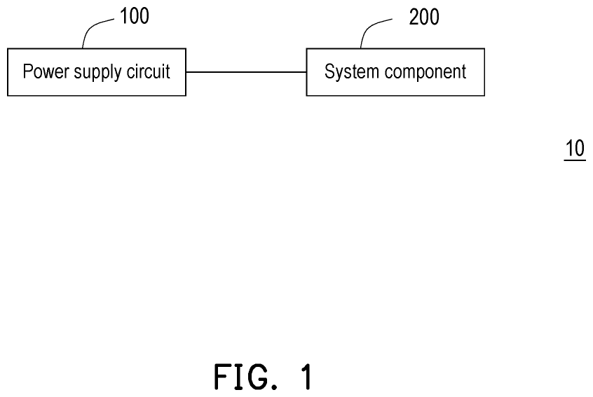

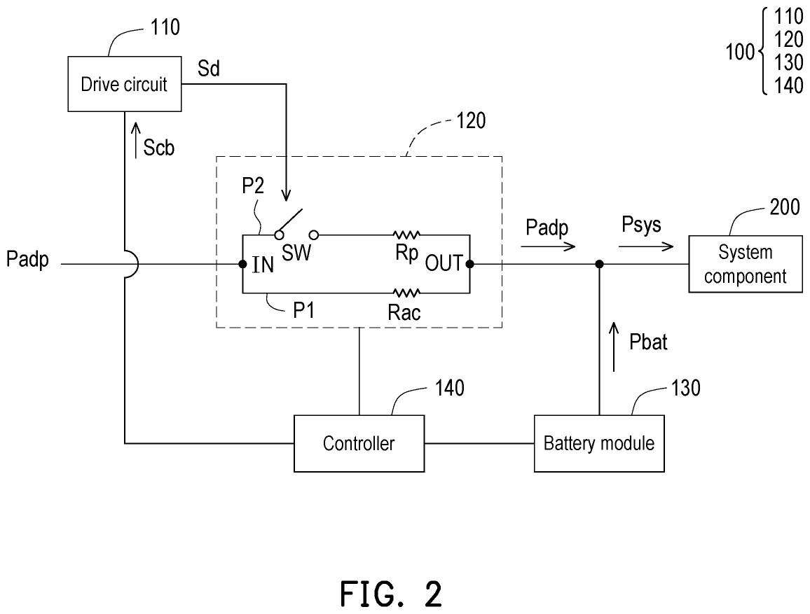

Please refer to FIG. 1 and FIG. 2 at the same time. The power supply circuit 100 of the present embodiment is adaptable for the electronic device 10. The electronic device 10 is, for example, a hand-held electronic product such as a notebook computer, a mobile phone, and a tablet computer, and is provided with a power supply circuit 100 and a system component 200, and inserted into a power adapter.

As shown in FIG. 2, the power supply circuit 100 includes a drive circuit 110, a feedback

resistor circuit 120, a battery module 130 and a controller 140. The drive circuit 110 is constituted by, for example, a resistance-capacitance (RC) circuit. The drive circuit 110 may receive the charger boost indication signal Scb from the controller 140 and generate the drive signal Sd according to the charger boost indication signal Scb. The charger boost indication signal Scb may be used to indicate whether the charger boost function of the electronic device 10 is on or off. For example, the charger boost indication signal Scb may indicate the current state of the charger boost function through its logic level or the information contained in the signal, but the disclosure is not limited thereto. When the drive circuit 110 receives the charger boost indication signal Scb indicating that the charger boost function is turned on, the drive circuit 110 generates the drive signal Sd of the first logic level. When the drive circuit 110 receives the charger boost indication signal Scb indicating that the charger boost function is turned off, the drive circuit 110 generates the drive signal Sd of the second logic level.

The feedback resistor circuit 120 is coupled to the drive circuit 110. The feedback resistor circuit 120 has a feedback resistance value that changes in response to the resistor signal Sd, and receives the DC power supply Padp supplied by the power adapter to supply power to the system component 200. In FIG. 2, the feedback resistor circuit 120 includes an input terminal IN, an output terminal OUT, a first feedback resistor Rac, a second feedback resistor Rp, and a charger boost switch SW. The system component 200 includes, for example, a central processing unit (CPU), a graphics processing unit (GPU) and other various processing chips on the motherboard of the electronic device 10.

The input terminal IN is configured to receive the DC power supply Padp. The output terminal OUT is coupled to the system element 200. The first feedback resistor Rac is coupled to the first circuit path Pl between the input terminal IN and the output terminal OUT. The second feedback resistor Rp is coupled to the second circuit path P2 between the input terminal IN and the output terminal OUT.

The charger boost switch SW is connected in series with the second feedback resistor Rp on the second circuit path P2, and is turned on or off according to the drive signal Sd. Specifically, the charger boost switch SW may be turned on according to the drive signal Sd of the first logic level, and may be turned off according to the drive signal Sd of the second logic level. It should be noted that in this embodiment, the first logic level may be logic 1 or logic 0, and the second logic level may be logic 0 or 1 complementary to the first logic level, and there is no fixed limitation.

The feedback resistance value of the feedback resistor circuit 120 is the resistance value between the input terminal IN and the output terminal OUT, which may be obtained, for example, by detecting the cross-voltage between the input terminal IN and the output terminal OUT. As shown in FIG. 2, when the charger boost switch SW is turned on, the feedback resistance value is equal to the resistance value of the first feedback resistor Rac and the second feedback resistor Rp connected in parallel. When the charger boost switch SW is turned off, the feedback resistance value is equal to the resistance value of the first feedback resistor Rac. Therefore, the feedback resistance value of the feedback resistor circuit 120 will change in response to the drive signal Sd.

The battery module 130 may be a built-in or an external battery module, and provide the battery power supply Pbat to the system component 200. The battery module 130 includes, for example, a battery cell set and a battery gauge IC. A battery cell set is composed of, for example, one or more battery cells (battery cells). The battery metering chip may calculate the stored power and the charging and discharging current of the battery module 130.

The controller 140 is, for example, a charger controller, which is coupled to the drive circuit 110, the feedback resistor circuit 120 and the battery module 130. The controller 140 may detect the cross-voltage between the input terminal IN and the output terminal OUT to read the feedback resistance value of the feedback resistor circuit 120, and control the battery power supply Pbat provided by the battery module 130 according to the feedback resistance value of the feedback resistor circuit 120. Specifically, the controller 140 may obtain the current information of the DC power supply Padp according to the feedback resistance value of the feedback resistor circuit 120. In the meantime, the battery metering chip in the battery module 130 sends a command to the controller 140 to notify the controller 140 to read the operation information of the battery metering chip (such as charging or discharging, the magnitude of the charging and discharging current, etc.). In this way, the controller 140 may calculate the total load power of the system component 200 according to the current information of the DC power supply Padp and the operation information of the battery metering chip, and determine whether the system component 200 operates in an overloaded state according to the calculated total load power of the system component 200.

In this embodiment, the heavy load state is, for example, a state in which the total load power of the system component 200 is higher than a specific power that enables the charger boost function because the electronic device 10 executes an application program with high power consumption. When the system component 200 is operating in a heavy load state, the controller 140 turns on the charger boost function, and the system power supply Psys received by the system component 200 is jointly supplied by the DC power supply Padp and the battery power supply Pbat. From the perspective of the controller 140, it is necessary to consider the power limit value of the DC power supply Padp (for example, 85% of the maximum rated output power of the power adapter), so the controller 140 is able to dynamically control battery power supply Pbat supplied by the battery module 130 to make the system power supply Psys meet the requirements of the current system component 200 as much as possible. In practical applications, for example, the system power supply Psys may be converted into a corresponding predetermined voltage via a voltage regulator to supply power to various system components 200.

On the other hand, when the system component 200 is not operating in the heavy load state, the controller 140 will not turn on the charger boost function, and the system power supply Psys received by the system component 200 will be completely supplied by the DC power supply Padp, and the battery module 130 does not need to provide the battery power supply Pbat to the system component 200. Not only that, if there is still a remaining wattage after the power of the system power supply Psys is deducted from the power of the DC power supply Padp, the remaining wattage may be used to charge the battery module 130. However, if there is no remaining wattage after deducting the power of the system power supply Psys from the power of the DC power supply Padp, the battery module 130 cannot be charged. It should be noted that, when the system component 200 is not operating in a heavy load state, the maximum power value of the DC power supply Padp is, for example, locked to a power limit value of the DC power supply Padp.

In this embodiment, when the system component 200 is operating in a heavy load state, the controller 140 may send a corresponding charger boost indication signal Scb to the drive circuit 110, so as to reduce the feedback resistance value through the drive signal Sd.

Furthermore, when the system component 200 is not operating in the heavy load state, the controller 140 turns off the charger boost function, and transmits the charger boost indication signal Scb indicating that the charger boost function is turned off to the drive circuit 110, making the drive circuit 110 turn off the charger boost switch SW through the drive signal Sd of the second logic level. At this stage, the feedback resistance value of the feedback resistor circuit 120 is equal to the resistance value of the first feedback resistor Rac.

When the system component 200 is operating in the heavy load state, the controller 140 turns on the charger boost function to combine the DC power supply Padp and the battery power supply Pbat into the system power supply Psys received by the system component 200 according to the energy distribution ratio. Moreover, the controller 140 transmits a charger boost indication signal Scb indicating that the charger boost function is turned on to the drive circuit 110, so that the drive circuit 110 turns on the charger boost switch SW through the drive signal Sd of the first logic level. At this stage, the feedback resistance value of the feedback resistor circuit 120 will be transformed into the resistance value of the first feedback resistor Rac and the second feedback resistor Rp connected in parallel, and thus decreased.

In addition, when the system component 200 is operating in a heavy load state, since the feedback resistance value of the feedback resistor circuit 120 is equal to the resistance value of the first feedback resistor Rac and the second feedback resistor Rp connected in parallel, the function of controlling the feedback resistance value of the feedback resistor circuit 120 may be achieved by adjusting the resistance value of the second feedback resistor Rp.

The controller 140 may adjust the energy distribution ratio of the DC power supply Padp and the battery power supply Pbat in the system power supply Psys received by the system component 200 according to the feedback resistance value of the feedback resistor circuit 120. Specifically, when the system component 200 is operating in a heavy load state, the controller 140 turns on the charger boost function, and the battery module starts to supply the battery power supply Pbat to the system component 200. The controller 140 controls the power of the battery power supply Pbat to lock the DC power supply Padp provided by the power adapter to a power limit value. At this stage, if the feedback resistance value decreases due to the parallel connection of the first feedback resistor Rac and the second feedback resistor Rp, the current information of the DC power supply Padp read by the controller 140 will be lower than the actual current value of the DC power supply Padp, so that the controller 140 may generate a judgment that the DC power supply Padp provided by the power adapter is still sufficient and has not been adjusted to the power limit value. Accordingly, the power of the battery power supply Pbat provided by the battery module 130 is reduced by adjusting the energy distribution ratio of the DC power supply Padp and the battery power supply Pbat in the system power supply Psys.

In response to the reduction of the power of the battery power supply Pbat, the power of the DC power supply Padp provided by the power adapter will be increased, and raised to exceed the power limit value (for example, increased to 90% or 95% or even 100% of the maximum rated output power of the power adapter). When the feedback resistance value of the feedback resistor circuit 120 is low, the controller 140 makes the proportion of the battery power supply Pbat in the system power supply Psys to be low, thereby increasing the power of the DC power supply Padp. In this way, the method of adjusting the energy distribution ratio of the system power supply Psys in the above-mentioned embodiment prevents the power of the DC power supply Padp provided by the power adapter from being locked (limited) to the power limit value, but adjusted to exceed the power limit value. In this way, it is possible to fully utilize the energy of the power adapter, and the power consumption of the battery module 130 is reduced.

In this embodiment, the resistance value of the second feedback resistor Rp is greater than the resistance value of the first feedback resistor Rac. The first feedback resistor Rac is, for example, 5 milliohms. When the system component 200 is operating in a heavy load state, the higher the second feedback resistor Rp will make the feedback resistance value of the feedback resistor circuit 120 (the resistance value obtained after the first feedback resistor Rac is connected in parallel with the second feedback resistor Rp) to be higher and closer to the resistance value of the first feedback resistor Rac, so that the current information of the DC power supply Padp obtained by the controller 140 is closer to the actual current value of the DC power supply Padp, and the range that the controller 140 adjusts the energy distribution ratio (the range of adjusting the proportion of the battery power supply Pbat) is thus reduced.

Conversely, the lower the second feedback resistor Rp, the lower the feedback resistance

value of the feedback resistor circuit 120 and the farther away from the resistance value of the first feedback resistor Rac, so that the current information of the DC power supply Padp obtained by the controller 140 is lower than the actual current value of the DC power supply Padp, and the range that controller 140 adjusts the energy distribution ratio (the range of adjusting the proportion of the battery power supply Pbat) is thus increased. In this way, when the controller 140 adjusts the energy distribution ratio of the system power supply Psys, the adjustment range of the energy distribution ratio may be determined according to the resistance value of the second feedback resistor Rp, so as to properly slow down the decrease in the power of the battery module 130 when the system component 200 is operating in a heavy load state. In addition, once the range of adjusting the energy distribution ratio is increased, the user may operate the electronic device 10 in a heavy load state for a long time, which significantly affects the user experience and perception of operation.

To sum up, the power supply circuit of the present disclosure can actively reduce the feedback resistance value of the feedback resistor circuit when the system component is operating in a heavy load state, so as to break the power limit of the power adapter. In this way, it is possible to prevent the power of the battery from rapidly decreasing even when the power adapter is plugged in, thereby avoiding bad user experience and perception of operation.

What is claimed is:

1. A power supply circuit adaptable for an electronic device, wherein the power supply circuit comprises:
a drive circuit, which receives a charger boost indication signal and generates a drive signal accordingly;
a feedback resistor circuit, which is coupled to the drive circuit, has a feedback resistance value that changes in response to the drive signal, and receives a DC power supply to supply a power to a system component;
a battery module, which provides a battery power supply to the system component; and
a controller, which is coupled to the drive circuit, the feedback resistor circuit and the battery module, and controls the battery power supply supplied by the battery module according to the feedback resistance value,
wherein when the system component is operating in a heavy load state, the controller sends the corresponding charger boost indication signal to the drive circuit, so as to reduce the feedback resistance value through the drive signal.

2. The power supply circuit according to claim 1, wherein feedback resistor circuit comprises:
an input terminal, which receives the DC power supply;
an output terminal, which is coupled to the system component;
a first feedback resistor, which is coupled to a first circuit path between the input terminal and the output terminal;
a second feedback resistor, which is coupled to a second circuit path between the input terminal and the output terminal; and
a charger boost switch, which is connected in series with the second feedback resistor on the second circuit path, and is turned on or off according to the drive signal,
wherein the feedback resistance value is a resistance value between the input terminal and the output terminal.

3. The power supply circuit according to claim 2, wherein when the system component is operating in the heavy load state, the controller sends the charger boost indication signal indicating that a charger boost function is turned on to the drive circuit, so that the drive circuit turns on the charger boost switch through the drive signal,
when the system component is not operating in the heavy load state, the controller sends the charger boost indication signal indicating that the charger boost function is turned off to the drive circuit, so that the drive circuit turns off the charger boost switch through the drive signal.

4. The power supply circuit according to claim 2, wherein when the system component operates in the heavy load state, the feedback resistance value is controlled by adjusting a resistance value of the second feedback resistor.

5. The power supply circuit according to claim 2, wherein a resistance value of the second feedback resistor is greater than a resistance value of the first feedback resistor.

6. The power supply circuit according to claim 1, wherein when the system component operates in the heavy load state, the DC power supply and the battery power supply are combined into a system power supply received by the system component according to an energy distribution ratio.

7. The power supply circuit according to claim 6, wherein the controller adjusts the energy distribution ratio according to the feedback resistance value.

8. The power supply circuit according to claim 7, wherein when the feedback resistance value is low, the controller makes a proportion of the battery power supply in the system power supply to be low, thereby increasing a power of the DC power supply.

9. The power supply circuit according to claim 7, wherein when the controller adjusts the energy distribution ratio, a range of adjusting the energy distribution ratio is determined according to a resistance value of the second feedback resistor.

10. The power supply circuit according to claim 1, wherein when the system component is not operating in the heavy load state, a maximum power value of the DC power supply is locked to a power limit value.

11. The power supply circuit according to claim 10, wherein when the system component is operating in the heavy load state, a power of the DC power supply is increased to exceed a power limit value in response to a reduction in a power of the battery power supply.
